(19) United States
(12) Patent Application Publication
(10) Pub. No.: US 2012/0016115 A1
(43) Pub. Date: Jan. 19, 2012

(54) APPARATUS FOR MANUFACTURING GEL PARTICLE AND METHOD FOR MANUFACTURING GEL PARTICLE

(75) Inventor: Katsuya IDE, Suwa-shi (JP)

(73) Assignee: SEIKO EPSON CORPORATION, Tokyo (JP)

(21) Appl. No.: 13/179,128

(22) Filed: Jul. 8, 2011

(30) Foreign Application Priority Data
Jul. 14, 2010 (JP) 2010-159512

(51) Int. Cl. C08B 37/00; B01J 19/00

(52) U.S. Cl. 536/124; 422/129

(57) ABSTRACT

An apparatus for manufacturing gel particle according to an embodiment of the invention is an apparatus for manufacturing gel particle of a first liquid and a second liquid by delivering the droplets of the first liquid including a gel particle-forming material to the second liquid that becomes the gel particle through reactions, and includes: a container that contains the second liquid; a flow mechanism unit that makes the second liquid flow in a spiral manner in the container; a tank that contains the first liquid; and an ejection mechanism unit that is communicated with the tank and is provided with a nozzle plate having a plurality of nozzles formed in a disposition that is along an array direction in which the liquid droplets of the first liquid are ejected on the second liquid made to flow in a spiral manner.

### BACKGROUND

1. Technical Field

The present invention relates to an apparatus for manufacturing gel particle and a method for manufacturing gel particle.

2. Related Art

A method is known in which an ejection liquid is ejected toward an ejection target liquid by the liquid droplet ejection method so as to manufacture gel particle. For example, a method and an apparatus are disclosed in which ejection nozzles disposed at a certain interval eject an ejection matter against a stationary ejection target liquid, and the ejection matter ejected from the nozzles by the liquid droplet ejection method and the stationary ejection target liquid are made to react with each other so as to manufacture gel particle (for example, refer to JP-A-2001-232178).

However, in the related art, when finer liquid droplets are ejected at a smaller interval or the like, as shown in the drawings in JP-A-2001-232178, since the ejection target liquid is stationary, the fine liquid droplets come close with each other and join on the surfaces of the liquid of the ejection target liquid so that there is a possibility that gel particle cannot be recovered separately.

### SUMMARY

An advantage of some aspects of the invention is to solve at least part of the above problems and the invention can be implemented as the following forms or application examples.

### APPLICATION EXAMPLE 1

This application example of the invention is directed to an apparatus for manufacturing gel particle of a first liquid and a second liquid by delivering the droplets of the first liquid including a gel particle-forming material to the second liquid that becomes the gel particle through reactions, including a container that contains the second liquid; a flow mechanism unit that makes the second liquid flow in a spiral manner in the container; a tank that contains the first liquid; and an ejection mechanism unit that is communicated with the tank and is provided with a nozzle plate having a plurality of nozzles formed in a disposition that is along an array direction in which the liquid droplets of the first liquid are ejected on the second liquid made to flow in a spiral manner, in which the smooth areas on the surfaces of the second liquid and the areas in which the plurality of nozzles is arrayed are overlapped in a direction parallel to the surfaces of the second liquid, and the flow direction of the second liquid and the array direction of the plurality of nozzles intersect with each other.

According to the above configuration, even when the first liquid is continuously ejected toward the second liquid by a liquid ejection unit, since the second liquid is made to flow in a spiral manner, gel particle produced by the reactions between the first liquid and the second liquid does not join, and thus the gel particle can be obtained separately.

At least, with regard to the liquid droplets of the first liquid ejected from the liquid ejection unit, the size of the liquid droplets or the speed, direction, and the like of ejection are controlled reliably and easily. Therefore, the liquid droplets of the first liquid are ejected in a predetermined size so as to reliably come into contact with the second liquid, and thus can become gel particle with a uniform size. In this case, the first liquid may be ejected by a dispenser or the like, or by an ink jet method. The gel particle of the first liquid ejected in the form of liquid droplets corresponds to the microcapsule in JP-A-2001-232178.

### APPLICATION EXAMPLE 2

In the above apparatus for manufacturing gel particle, the intersection may occur at a right angle.

According to this configuration, even when the first liquid is continuously ejected toward the second liquid by the liquid ejection unit, since it is possible to obtain the maximum distance between the respective nozzles with respect to the flow direction of the second liquid, gel particle produced by the reactions between the first liquid and the second liquid does not join, and thus the gel particle can be obtained separately.

### APPLICATION EXAMPLE 3

In the above apparatus for manufacturing gel particle, a stirrer may be used in the flow mechanism unit so that the second liquid is made to flow in a spiral manner by a rotor.

According to this configuration, the second liquid can easily be made to flow in a spiral manner in the container that contains the second liquid.

### APPLICATION EXAMPLE 4

In the above apparatus for manufacturing gel particle, the plurality of ejection mechanism units may be provided.

According to this configuration, since the apparatus for manufacturing gel particle can include multiple ejection mechanism units, a lot of gel particle can be manufactured in a short time. Since the ejection amount and type of the ejected first liquid can vary with the respective ejection mechanism units, a variety of types or sizes of gel particle can be manufactured at one time.

### APPLICATION EXAMPLE 5

In the above apparatus for manufacturing gel particle, the ejection mechanism units may be provided symmetrically around the rotation axis of the second liquid that flows in a spiral manner.

According to this configuration, even when the first liquid is continuously ejected toward the second liquid by the liquid ejection unit, since the respective liquid ejection units are separated from one another, gel particle produced by the reactions between the first liquid and the second liquid ejected by the respective liquid ejection units does not join, and thus the gel particle can be obtained separately.

### APPLICATION EXAMPLE 6

In the above apparatus for manufacturing gel particle, the ejection mechanism units may be provided concentrically around the rotation axis of the second liquid that flows in a spiral manner.

According to this configuration, since the flow rates of the second liquid become identical in the respective ejection mechanism units, gel particle can have a uniform size.

### APPLICATION EXAMPLE 7

The above apparatus for manufacturing gel particle may further include a level sensor that senses the level of the second liquid in the container and a supply device that supplies the second liquid to the container.

According to this configuration, since the absorption of the second liquid can be stopped when the second liquid reaches a certain level, the distance between the surface of the nozzle plate in the ejection mechanism unit and the surface of the second liquid (platen gap) can be managed. Therefore, the liquid droplets of the first liquid are ejected in a predetermined size so as to reliably come into contact with the second liquid, and thus can become gel particle with a uniform size.

### APPLICATION EXAMPLE 8

In the above apparatus for manufacturing gel particle, the ejection mechanism unit may be an ink jet head.

According to this configuration, the size of the first liquid or the speed, direction, and the like of ejection can be controlled more reliably and more easily. Therefore, it is possible to suppress variation in locations where the first liquid ejected toward the second liquid and the second liquid come into contact, or the like, and thus the first liquid can always become gel particle under the same conditions.

### APPLICATION EXAMPLE 9

This application example of the invention is directed to a method for manufacturing gel particle using any one of the above apparatuses for manufacturing gel particle.

According to this configuration, even when the first liquid is continuously ejected toward the second liquid by the liquid ejection unit, since the second liquid is made to flow in a spiral manner, gel particle produced by the reactions between the first liquid and the second liquid does not join, and thus the gel particle can be obtained separately.

At least, with regard to the liquid droplets of the first liquid ejected from the liquid ejection unit, the size of the liquid droplets or the speed, direction, and the like of ejection are controlled reliably and easily. Therefore, the liquid droplets of the first liquid are ejected in a predetermined size so as to reliably come into contact with the second liquid, and thus can become gel particle with a uniform size.

### BRIEF DESCRIPTION OF THE DRAWINGS

The invention will be described with reference to the accompanying drawings, wherein like numbers reference like elements.

FIG. 1 is a perspective view showing the apparatus for manufacturing gel particle according to the present embodiment.

FIG. 2 is an elevation view showing the apparatus for manufacturing gel particle according to the embodiment.

FIG. 3 is a plan view showing the apparatus for manufacturing gel particle according to the embodiment.

FIG. 4 is a cross-sectional view showing the apparatus for manufacturing gel particle according to the embodiment.

FIG. 5 is a block diagram showing the control structure of the apparatus for manufacturing gel particle according to the embodiment.

FIG. 6 is a flow chart showing a process for manufacturing gel particle according to the embodiment.

FIGS. 7A to 7C are plan views showing the respective plates corresponding to the multiple heads in modification examples.

### DESCRIPTION OF EXEMPLARY EMBODIMENTS

Hereinafter, specific embodiments of the method for manufacturing gel particle and the apparatus for manufacturing gel particle will be described with reference to the accompanying drawings. In the apparatus for manufacturing gel particle according to the embodiment, liquids are ejected by an ink jet method so as to become gel particle.

Firstly, an example of the apparatus for manufacturing gel particle will be described.

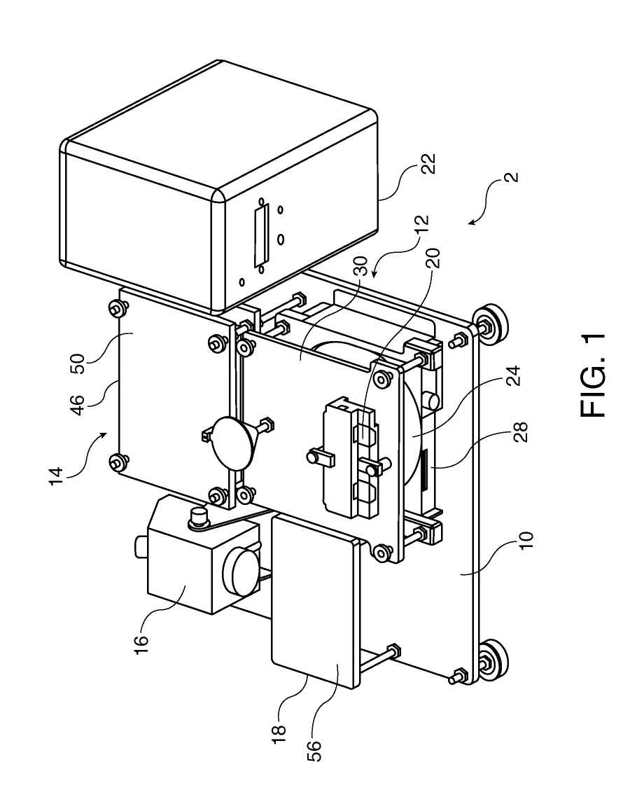

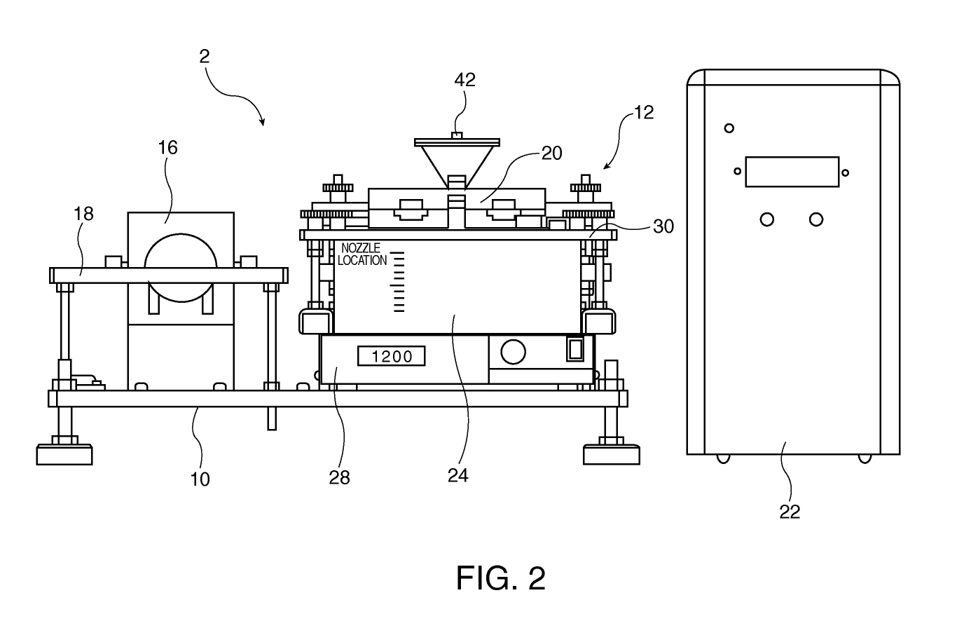

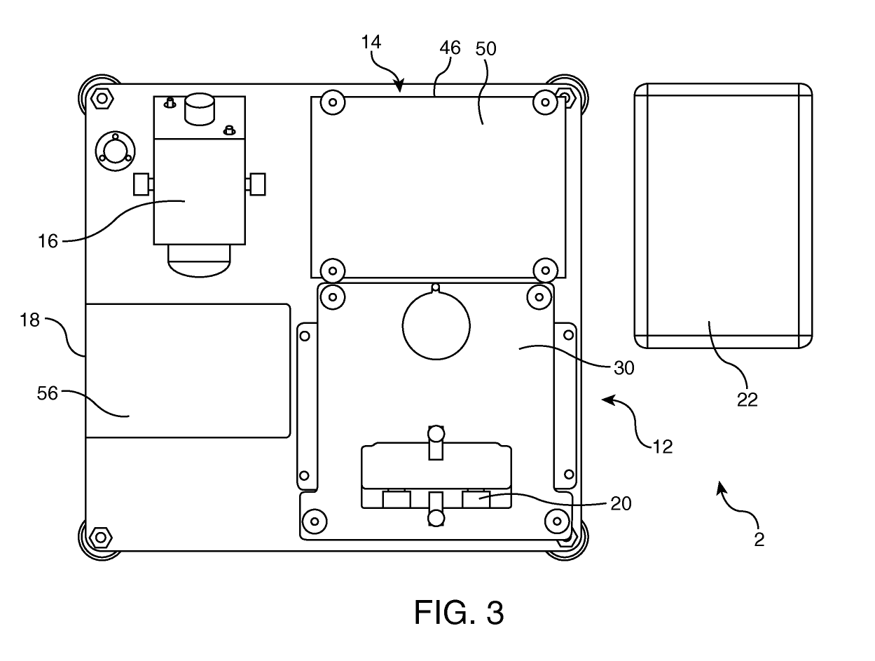

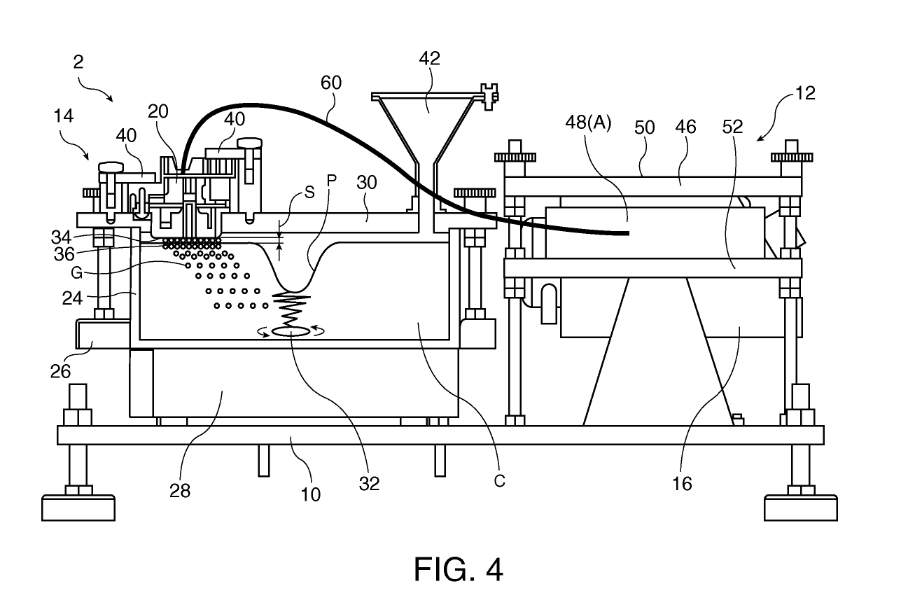

FIG. 1 is a perspective view showing the apparatus for manufacturing gel particle according to the embodiment; FIG. 2 is an elevation view showing the apparatus for manufacturing gel particle according to the embodiment; FIG. 3 is a plan view showing the apparatus for manufacturing gel particle according to the embodiment; and FIG. 4 is a cross-sectional view showing the apparatus for manufacturing gel particle according to the embodiment. As shown in FIG. 1 to FIG. 4, an apparatus for manufacturing gel particle 2 according to the embodiment includes a base plate 10, a gel particle producing unit 12 provided on the base plate 10, an ink pack unit 14 provided in the vicinity of the gel particle producing unit 12 on the base plate 10, a head suction pump 16 provided in the vicinity of the gel particle producing unit 12 on the base plate 10, a first worktable 18 provided in the vicinity of the gel particle producing unit 12 on the base plate 10, and a head driving box (control unit) 22 that drives a head (ejection mechanism unit) 20 of the gel particle producing unit 12.

The base plate 10 includes a Petri dish guide plate 26 that guides a Petri dish (container) 24 of the gel particle producing unit 12 to the predetermined location.

The gel particle producing unit 12 includes a stirrer (flow mechanism unit) 28, a Petri dish 24, a plate 30, and the head 20.

The stirrer 28 includes a rotor 32. The rotor 32 is placed in the Petri dish 24. The stirrer 28 rotates the rotor 32 in the Petri dish 24 so as to make a calcium chloride solution (a second liquid) C flow in the Petri dish 24 in a spiral manner. Thereby, the stirrer 28 performs a role of preventing a phenomenon in which a sodium alginate solution (a first liquid) A in the Petri dish 24, which is delivered in droplet form, joins on the surface of the calcium chloride solution C so as to cause the failure of the production of gel particle G.

The Petri dish 24 is provided in the upper part of the stirrer 28. The center of the Petri dish 24 is in line with the rotation center of the rotor 32 in the stirrer 28. The Petri dish 24 is made of a material which allows observation, such as transparent acryl or the like, and is formed into a tube shape so that the flow state of the calcium chloride solution C and the gel particle G can be visually confirmed. The Petri dish 24 is made of transparent acryl, transparent or semi-transparent polypropylene, or the like, but the material is not limited thereto, and may be an opaque material or may be glass, metals, or the like as long as the material does not cause the alteration or chemical reaction of the sodium alginate A, the calcium chloride solution C, and the produced gel particle G. The calcium chloride solution C contained in the Petri dish 24 has a concentration of 2%.

The plate 30 is provided on the Petri dish 24. The plate 30 keeps the distance between the surface of the nozzle plate 34 in the head 20 and the surface of the calcium chloride solution C constant. The plate 30 is made of a transparent acryl sheet. Thereby, it is possible to observe the state of the spiral flow of the calcium chloride solution C from the outside of the plate 30. The plate 30 includes a square hole 38 that exposes the surfaces of nozzles 36 in the head 20, a head fixing unit 40 that fixes the head 20, and a calcium chloride solution supply opening 42 used when the calcium chloride solution C is supplied to the Petri dish 24. The calcium chloride solution supply opening 42 is a covered funnel. The covered funnel is provided on the plate 30. The cover of the covered funnel is present in the upper part of the funnel and can slide right and left. Thereby, the covered funnel can prevent particles from intruding into the funnel and the calcium chloride solution C from being ejected outside the funnel (safety measure). The square hole 38 is provided with a sealing member, such as waterproof rubber, an O-ring, or the like.

The ink pack unit 14 includes a second worktable 46 and an ink pack (tank) 48 provided in the second worktable 46. The second worktable 46 includes a mirror-like metal plate-shaped top plate 56 and a middle plate 52 provided below the top plate 56. The ink pack 48 is provided on the middle plate 52. The ink pack unit 14 contains the sodium alginate solution A, and is provided in the vicinity of the head 20. The ink pack unit 14 can move up and down by moving the middle plate 52 in the second worktable 46 up and down. A top plate 50 is constituted by a metal plate and protects the ink pack unit 14 from impacts from above. The metal plate has mirror-like surfaces. Thereby, the metal plate can be used to visually confirm whether or not the nozzles in the head 20 eject. The mirror-like finish is performed by coating non-electrolytic nickel plating on aluminum surfaces. Thereby, the weight of the mirror-like metal plate can be reduced. The supply opening in the ink pack unit 14 is as high as the surface of the nozzle plate 34. Thereby, dripping from the nozzles 36 or intrusion of air into the nozzles 36 can be prevented. The ink pack unit 14 is made of, for example, transparent or semi-transparent polyethylene or the like. In the apparatus for manufacturing gel particle 2, the sodium alginate solution A contained in the ink pack unit 14 has a concentration of 1%.

The head suction pump 16 includes a cleaning mechanism to prevent clogging in the head 20. The cleaning mechanism performs forcible suction of liquid droplets from the head 20 or head cleaning, for example, after the predetermined number of liquid droplets is ejected or when an image analyzing unit 54 analyzes the gel particle G for abnormalities, thereby achieving the stable operation of the apparatus for manufacturing gel particle 2.

The first worktable 18 includes the mirror-like metal plate-shaped top plate 56. The mirror-like metal plate achieves the stable operation of the head 20, for example, by ejecting the sodium alginate solution A on the mirror-like metal plate from the head 20 and allowing visual confirmation of whether or not the nozzles in the head 20 have ejected from the ejection state in advance before the manufacture of gel particle.

The head 20 includes the nozzle plate 34 having a plurality of nozzles 36 formed to eject the sodium alginate solution A. According to the above, the apparatus for manufacturing gel particle can include multiple ejection mechanism units, and a lot of gel particle G can be manufactured in a short time. Since the ejection amount and type of the sodium alginate solution A ejected from the respective heads 20 can vary, a variety of types or sizes of gel particle can be manufactured at one time. The nozzle 36 has a diameter of, for example, 100 μm, and the sodium alginate solution A ejected from the nozzles 36 at an ejection frequency of 10 Hz or higher has a flow rate of 1 mm/s. The size of droplet ejected from the nozzle 36 is about 50 μm. The sodium alginate solution A is contained in the ink pack 48, is guided to a pipe 60, and is supplied to the head 20. The smooth areas in the surface of the calcium chloride solution C and areas in which the plurality of nozzles 36 is arrayed are overlapped in a direction parallel to the surfaces of the calcium chloride solution C. The flow direction of the calcium chloride solution C and the array direction of the plurality of nozzles 36 intersect with each other. The flow direction of the calcium chloride solution C and the array direction of the plurality of nozzles 36 may also be structured to intersect to form a right angle. According to the above, even when the sodium alginate solution A is continuously ejected toward the calcium chloride solution C by the head 20, since it is possible to obtain the maximum distance between the respective nozzles 36 with respect to the flow direction of the calcium chloride solution C, gel particle G produced by the reactions between the sodium alginate solution A and the calcium chloride solution C does not join, and thus the gel particle G can be obtained separately. The nozzles 36 are formed in a row in the head 20, but are not limited to being formed in a row, and may be formed in a plurality of rows. The distance (interval) with the nozzle plates 34 in the head 20 and the surfaces of the calcium chloride solution C made to flow in a spiral manner by the stirrer 28 is defined.

In the apparatus for manufacturing gel particle 2, the sodium alginate solution A is ejected toward the calcium chloride solution C made to flow in a spiral manner in the Petri dish 24 from the nozzles 36 by the liquid droplet ejection method, thereby obtaining the gel particle G produced by the chemical reaction between the sodium alginate solution A and the calcium chloride solution C in the Petri dish 24. Specifically, the sodium alginate solution A is ejected toward the calcium chloride solution C so that the sodium alginate solution A and the calcium chloride solution C chemically react so as to produce calcium alginate gel particle.

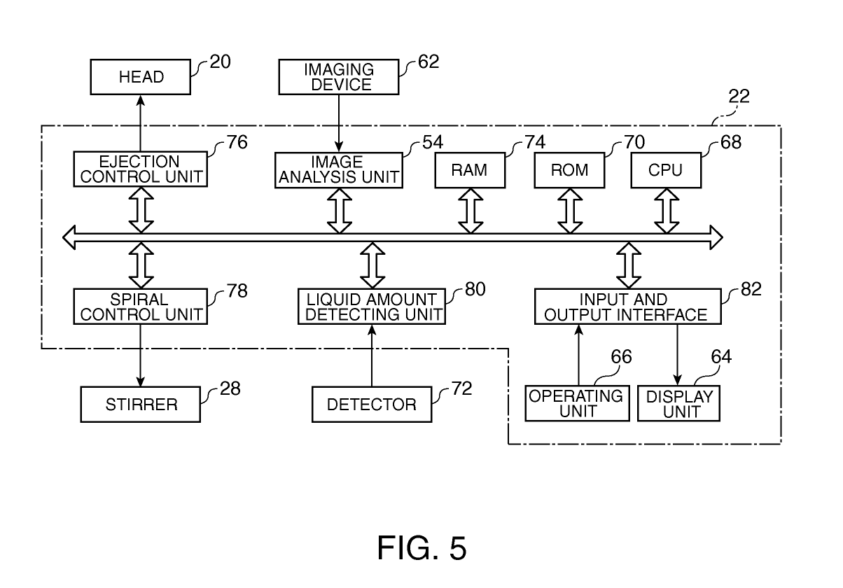

FIG. 5 is a block diagram showing the control structure of the apparatus for manufacturing gel particle 2 according to the embodiment. A control unit 22 includes a display unit 64 that displays gel particleatinization state determined through an imaging device 62, the operation state of the apparatus for manufacturing gel particle 2, or the like and an operating unit 66 through which commands or the like for the respective units in the apparatus for manufacturing gel particle 2 are input. In this case, a so-called personal computer is used as the control unit 22, and the details of the control unit 22 for controlling the apparatus for manufacturing gel particle 2 will be described below.

The control unit 22 includes a central processing unit (CPU) 68 that comprehensively controls the apparatus for manufacturing gel particle 2, a read only memory (ROM) 70 that stores programs or the like that the CPU 68 references to perform a variety of processes, such as the ejection of liquid droplets, or the like, and a random access memory (RAM) 74 that temporarily stores data or the like sent by the operating unit 66, the imaging device 62, and a detector 72. The control unit 22 is provided with an image analysis unit 54 that receives image data from the imaging device 62 and analyzes the image data, an ejection control unit 76 that controls the head 20, a spiral control unit 78 that controls the stirrer 28, and a liquid amount detecting unit 80 that receives the data of liquid amount from the detector 72, and an input and output interface 82 that performs input and output with the display unit 64 and the operating unit 66 or external devices.

The image analysis unit 54 receives images showing the gel particleatinization state of the sodium alginate solution A taken by the imaging device 62 and analyzes whether or not the solution is gel particle in a desired form. The analysis results are transmitted to the CPU 68, and the CPU 68 determines whether or not to continue ejection and sends commands to the ejection control unit 76 and the spiral control unit 78. The ejection control unit 76 controls the ejection of liquid droplets from the head 20 based on the commands from the CPU 68. The spiral control unit 78 controls the stirrer 28 to prevent the joining of the sodium alginate solution A on the surface of the calcium chloride solution C in response to the ejection of liquid droplets from the head 20 by the ejection control unit 76. The liquid amount detecting unit 80 receives the liquid amount of the calcium chloride solution C detected by the detector 72 in the ink pack 48 and determines whether or not the amount is an amount necessary for the continuation of ejection. The determination results are transmitted to the CPU 68, and the CPU 68 commands the ejection control unit 76 to stop when the liquid amount is determined to be deficient. In the case of stopping, the CPU 68 commands the display unit 64 to display a stopping alarm.

Next, a method for producing (manufacturing) the gel particle of the sodium alginate solution A by the apparatus for manufacturing gel particle 2 will be described based on a flow chart.

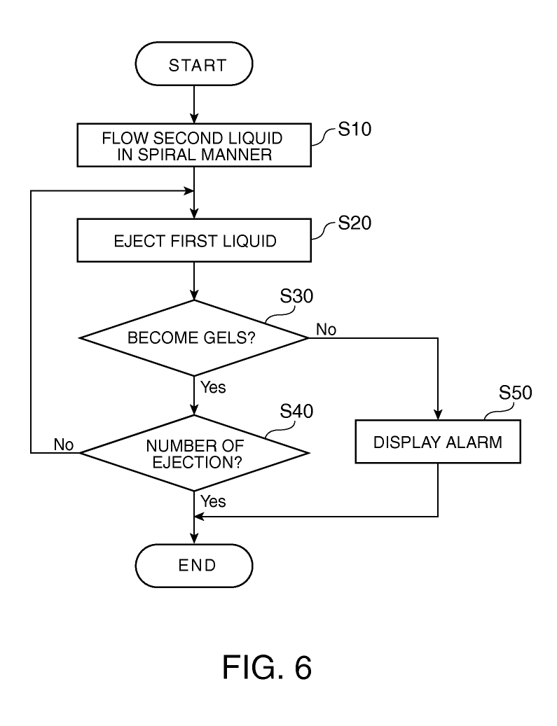

FIG. 6 is a flow chart showing a process for manufacturing gel particle according to the embodiment. This flowchart shows the flow of a single liquid droplet ejection.

As an advance preparation, a gel particle manufacturer feeds the calcium chloride solution C into the Petri dish 24. The calcium chloride solution C may be fed into the Petri dish 24 via the calcium chloride solution supply opening 42. The amount of the calcium chloride solution C is determined by defining the distance (platen gap) S between the surfaces of the nozzle plates 34 in the head 20 and the surface of the calcium chloride solution C. The amount of the calcium chloride solution C is measured by the scale mark printed on the side surface of the Petri dish 24. The amount of the calcium chloride solution C is measured from the weight of the calcium chloride solution C after the calcium chloride solution C is fed into the Petri dish 24 in advance by as much as a necessary distance between the surfaces of the nozzle plates 34 and the surface of the calcium chloride solution C. Next, the gel particle manufacturer measures a necessary weight of the calcium chloride solution C with an electronic balance and feeds the solution C via the calcium chloride solution supply opening 42.

Next, the gel particle manufacturer turns on the control unit 22 and selects the ejection pattern of liquid droplets. The ejection pattern refers to settings of the ejection conditions in accordance with liquids ejected from the nozzles 36 and includes the waveforms of voltage applied to piezoelectric elements or the like. In this case, the number of liquid droplets ejected is also included. An ejection pattern for ejecting the liquid droplets of the sodium alginate solution A is selected.

Next, the gel particle manufacturer confirms beforehand the ejection of the head 20 on the mirror-like metal plate of the top plate 56 in the first worktable 18. The sodium alginate solution A is pressed by the piezoelectric elements, not shown, included in the head 20 and thus is ejected from the nozzles 36 in liquid droplet form.

Next, the gel particle manufacturer sets the head 20 in the square hole 38 in the plate 30 on the Petri dish 24 and fixes the upper part of the head 20 by the head fixing unit 40. The head 20 is set on the smooth surface of the calcium chloride solution C, avoiding the dent P in the center portion caused by the rotation of the calcium chloride solution C. In the multiple nozzle head, the array direction of the nozzles 36 may be set perpendicular to the rotation direction of the calcium chloride solution C. In the multiple nozzle head, the array direction of the nozzles 36 may be set in an inclined manner to the rotation direction of the calcium chloride solution C.

After the above advance preparation is ended, firstly, in Step S10, the control unit 22 makes the calcium chloride solution C flow in a spiral manner with the rotor 32 using the stirrer 28.

Next, in Step S20, the control unit 22 ejects the liquid droplets of the sodium alginate solution A from the head 20 to the calcium chloride solution C made to flow in a spiral manner. The ejected liquid droplets are fed into the flowing calcium chloride solution C. Since the liquid droplets in this state react with the calcium chloride solution C so as to produce gel particle G, uniform-sized gel particle G can be obtained. After the ejection of the liquid droplets, Step S30 proceeds.

Next, in Step S30, the control unit 22 determines whether or not the gel particle is in a predetermined state. That is, it is determined whether or not the liquid droplets of the sodium alginate solution A have turned into the desired form of gel particle G. This determination is made by the image analysis unit 54 with reference to the images of the gel particle G taken by the imaging device 62. In the apparatus for manufacturing gel particle 2, the imaging device 62 takes images of the gel particle G recovered at the recovery net in a gel particle recovery unit, not shown. When the gel particle G is in a predetermined gel particle state, Step S40 proceeds, on the other hand, when the gel particle G is not in a predetermined gel particle state, a warning regarding the above fact is displayed in Step S50, and then the flow is ended. The ending of the flow stops the ejection of liquid droplets or the like.

When the gel particle G is in a predetermined gel particle state, in Step S40, whether or not the selected number of ejections has been performed is determined. The determination is made by the ejection control unit, not shown, that counts the number of ejections by the head 20. When the predetermined number of liquid droplets is ejected, the flow is ended, on the other hand, when the predetermined number of liquid droplets is not ejected, the flow moves back to Step S20.

When the flow moves back to Step S20, Step S20 is repeatedly performed until the predetermined number of liquid droplets is ejected. When the predetermined number of liquid droplets is ejected, the flow is ended. The head 20 and the stirrer 28 are turned off. The head 20 is removed, and the Petri dish 24 is slid and removed. Alternately, the head 20 and the plate 30 are removed, and the Petri dish 24 is covered and moved.

Thus far, an embodiment of the method for manufacturing gel particle using the apparatus for manufacturing gel particle 2 has been described. Hereinafter, the effects of the embodiment will be described.

(1) In the apparatus for manufacturing gel particle 2, even when the sodium alginate solution A is continuously ejected toward the calcium chloride solution C by the head 20, since the calcium chloride solution C is made to flow in a spiral manner, the gel particle G produced by the reactions between the sodium alginate solution A and the calcium chloride solution C does not join, and thus the gel particle can be obtained separately.

(2) At least, with regard to the liquid droplets of the sodium alginate solution A ejected from the head 20, the size of the liquid droplets or the speed, direction, and the like of ejection are controlled reliably and easily. Therefore, the liquid droplets of the sodium alginate solution A are ejected in a predetermined size so as to reliably come into contact with the calcium chloride solution C, and thus can become gel particle with a uniform size. In this case, the sodium alginate solution A may be ejected by a dispenser or the like, or by an ink jet method.

(3) In the apparatus for manufacturing gel particle 2, since the head 20 adopts the ink jet method, the size of the liquid droplets of the sodium alginate solution A or the speed, direction, and the like of ejection can be controlled more accurately than any other ejection methods, whereby liquid droplets can always become gel particle with a uniform size under the same conditions. Particularly, even for fine gel particle G, the uniformization of the gel particle G can be achieved.

(4) Since the sodium alginate solution A is ejected from the head 20 in a liquid droplet state, gel particle G with the uniform size of 10 μm can be obtained. When the size of the liquid droplets is adjusted, the gel particle G with a desired size other than 10 μm that is produced in the embodiment can be easily obtained.

(5) Since the calcium chloride solution C is made to flow in a spiral manner in the Petri dish 24 instead of being stationary, it is possible to prevent the contamination of the calcium chloride solution C, the generation of viable bacteria, or the like.

The method for manufacturing gel particle and the apparatus for manufacturing gel particle 2 are not limited to the above embodiments, and the method for manufacturing gel particle and the apparatus for manufacturing gel particle 2 in the form of the following variations can also obtain the same effects as the embodiments.

### Variation 1

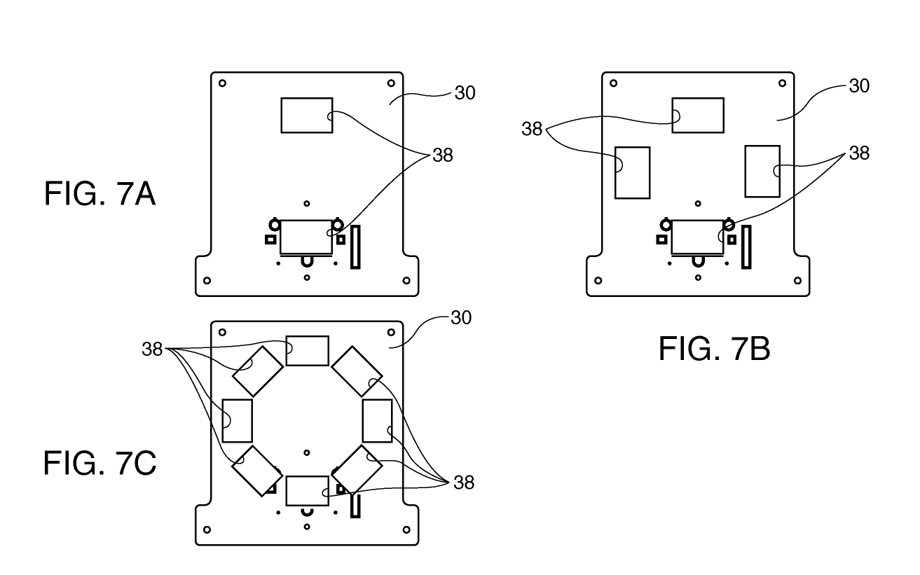

FIGS. 7A to 7C show plan views showing the respective plates corresponding to multiple heads in variations. In each of the above embodiments, the number of the heads 20 shown in the drawing to be disposed in the gel particle producing unit 12 is one, but is not limited thereto, and a structure may be adopted in which a plurality of heads is disposed in the gel particle producing unit 12. Specifically, as shown in FIGS. 7A and 7B, the plurality of square holes 38 may be disposed symmetrically around the dent P in the sodium alginate solution A on the plate 30. According to the above, even when the sodium alginate solution A is continuously ejected toward the calcium chloride solution C by the respective heads 20, since the respective heads 20 are separated from one another, gel particle G produced by the reactions between the sodium alginate solution A and the calcium chloride solution C ejected by the respective heads 20 does not join, and thus the gel particle G can be obtained separately. As shown in FIG. 7C, the plurality of square holes 38 may be disposed concentrically around the dent P in the sodium alginate solution A on the plate 30. According to the above, since the flow rates of the calcium chloride solution C become identical in the respective ejection mechanism units, gel particle can be made with a uniform size.

### Variation 2

The head 20 that ejects the liquid droplets of the sodium alginate solution A may adopt a method in which the sodium alginate solution A is delivered in droplet form by, for example, a dispenser or the like, instead of the ink jet method. According to the above, the liquid droplets of the sodium alginate solution A can be ejected toward the calcium chloride solution C accurately, and gel particle G can be produced. As such, by using the ink jet method in conjunction with a variety of ejection methods, it is possible to provide apparatuses for manufacturing gel particle in accordance with a variety of solutions to be ejected. In order to eject solutions with a high viscosity, a mechanism that heats solutions so as to lower the viscosity may be provided in the apparatus for manufacturing gel particle 2.

### Variation 3

The detector 72 in the ink pack 48 may detect information on the concentration or the like of a liquid in addition to the amount of a liquid to be stored.

### Variation 4

With regard to the distance (platen gap) S between the surface of the nozzle plate 34 in the head 20 and the surface of the calcium chloride solution C, the apparatus for manufacturing gel particle may include a level sensor, not shown, in the Petri dish 24 and may stop the absorption (of the calcium chloride solution C) when the calcium chloride solution C reaches a certain level. According to the above, since the absorption of the calcium chloride solution C can be stopped when the calcium chloride solution C reaches a certain level, the distance (platen gap) between the surface of the nozzle plate 34 in the head 20 and the surface of the calcium chloride solution C can be managed. Therefore, the liquid droplets of the sodium alginate solution A are ejected in a predetermined size so as to reliably come into contact with the calcium chloride solution C, and thus can become gel particle with a uniform size.

### Variation 5

In each of the above embodiments, examples in which the sodium alginate solution A and the calcium chloride solution C are used as the first liquid and the second liquid, respectively, in order to obtain the gel particle G of alginic acid are described. In addition to the above, methods, for example, in which a potassium alginate solution and a barium chloride solution are used as the first liquid and the second liquid, respectively, in order to obtain the gel particle G of alginic acid may be adopted, and any liquids that react with the first liquid including a gel particle-forming material so as to become gel particle may be applied as the second liquid. Desired materials may also be included in the gel particle G, and, for example, a curing agent, a drug, oxygen, cells, a pigment, a catalyst, nano-particles, and fluorescent particles may be included in the sodium alginate solution A, which is ejected in liquid droplet form. Thereby, it is possible to obtain gel particle G including a drug, oxygen, cells, a pigment, a catalyst, nano-particles, and fluorescent particles sealed therein. For example, gel particle G including a curing agent or a drug sealed therein enables usage in which, when an external pressure is applied, the curing agent or the drug is released from the gel particle G and begins a curing action or a medical action, and, furthermore, enables the manufacture of gel particle G that produces a curing action or a medical action even in confined spaces by forming fine particles of a liquid. Particularly, by manufacturing fine gel particle G including a curing agent sealed therein as a dental material, it is possible to provide an appropriate amount of curing agent to confined spaces, such as tooth crowns or the like. As a result, it is possible to prevent the use of a curing agent in an amount more than necessary so as to prevent the waste of the curing agent, and also to reduce the costs of dental treatment. The sizes or concentrations of droplets in the respective liquids are not limited to the settings in each of the embodiments.

This application claims priority to Japanese Patent Application No. 2010-159512, filed on Jul. 23, 2010, the entirety of which is hereby incorporated by reference.

What is claimed is:

1. An apparatus for manufacturing gel particle of a first liquid and a second liquid by delivering the droplets of the first liquid including a gel particle-forming material to the second liquid that becomes the gel particle through reactions, comprising:
a container that contains the second liquid;
a flow mechanism unit that makes the second liquid flow in a spiral manner in the container;
a tank that contains the first liquid; and
an ejection mechanism unit that is communicated with the tank and is provided with a nozzle plate having a plurality of nozzles formed in a disposition that is along an array direction in which the liquid droplets of the first liquid are ejected on the second liquid made to flow in a spiral manner,
wherein the smooth areas on the surfaces of the second liquid and the areas in which the plurality of nozzles is arrayed are overlapped in a direction parallel to the surfaces of the second liquid, and
the flow direction of the second liquid and the array direction of the plurality of nozzles intersect with each other.

2. The apparatus for manufacturing gel particle according to claim 1,
wherein the intersection occurs at a right angle.

3. The apparatus for manufacturing gel particle according to claim 1,
wherein a stirrer is used in the flow mechanism unit so that the second liquid is made to flow in a spiral manner by a rotor.

4. The apparatus for manufacturing gel particle according to claim 1,
wherein the plurality of ejection mechanism units is provided.

5. The apparatus for manufacturing gel particle according to claim 4,
wherein the ejection mechanism units are provided symmetrically around the rotation axis of the second liquid that flows in a spiral manner.

6. The apparatus for manufacturing gel particle according to claim 4,
wherein the ejection mechanism units are provided concentrically around the rotation axis of the second liquid that flows in a spiral manner.

7. The apparatus for manufacturing gel particle according to claim 1, further comprising:
a level sensor that senses the level of the second liquid in the container; and
a supply device that supplies the second liquid to the container.

8. The apparatus for manufacturing gel particle according to claim 1,
wherein the ejection mechanism unit is an ink jet head.

9. A method for manufacturing gel particle using the apparatuses for manufacturing gel particle according to claim 1.

10. A method for manufacturing gel particle using the apparatuses for manufacturing gel particle according to claim 2.

11. A method for manufacturing gel particle using the apparatuses for manufacturing gel particle according to claim 3.

12. A method for manufacturing gel particle using the apparatuses for manufacturing gel particle according to claim 4.

13. A method for manufacturing gel particle using the apparatuses for manufacturing gel particle according to claim 5.

14. A method for manufacturing gel particle using the apparatuses for manufacturing gel particle according to claim 6.

15. A method for manufacturing gel particle using the apparatuses for manufacturing gel particle according to claim 7.

16. A method for manufacturing gel particle using the apparatuses for manufacturing gel particle according to claim 8.
